(19) United States
(12) Patent Application Publication
(10) Pub. No.: US 2014/0167960 A1
(43) Pub. Date: Jun. 19, 2014

(54) Detecting Defective Shopping Carts

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/720,701

(22) Filed: Dec. 19, 2012

(51) Int. Cl. G08B 21/18

(52) U.S. Cl. CPC G08B 21/18
USPC 340/540

(57) ABSTRACT

Systems and methods are disclosed herein for identifying defective shopping carts are disclosed. A microphone is positioned to detect sound emitted by passing shopping carts and the output of the microphone is analyzed and compared to sound signatures for one or both of normal and defective shopping carts. If the output indicates a passing cart is defective one or more cart removal actions may be taken such as generating an audible alert, capturing an image of the defective cart, transmitting an alert to a store employee indicating one or both of a location of the cart and an identifier of the cart captured from an image or some other means. In some embodiments, a signal may be transmitted to a cart detected to be defective effective to lock one or more wheels of the cart.

### BACKGROUND

1. Field of the Invention

This invention relates to shopping carts and methods for removing defective shopping carts from circulation.

2. Background of the Invention

A universal experience of shoppers is the inconvenience of a defective shopping cart. A defective shopping cart may be functional but make irritating squeals and rattles that are indicative of impeding failure. A defective shopping cart may have a wheel that is completely locked or refuses to swivel. In any case, it can be frustrating to a shopper to deal with a defective cart or have to return a cart and find a properly functioning one. In some instances, a defective cart may be unsafe or cause property damage if a defective wheel renders the cart difficult to steer or biases the cart to turn unexpectedly.

The methods and systems disclosed herein provide a novel approaches for identifying defective shopping carts to facilitate their removal from circulation.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of a system for performing methods in accordance with embodiments of the invention;

FIG. 1B is a schematic block diagram of a system for locking a shopping cart wheel in accordance with embodiments of the invention;

FIG. 2 is a block diagram of a computing device suitable for implementing embodiments of the invention;

FIG. 3 is a block diagram of a method for removing defective shopping carts from circulation in accordance with embodiments of the invention;

FIG. 4 is a simulated plot of an acoustic signature of a shopping cart for use in accordance with embodiments of the invention; and

FIG. 5 is a process flow diagram of a method for identifying defective cart signatures in accordance with embodiments of the invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

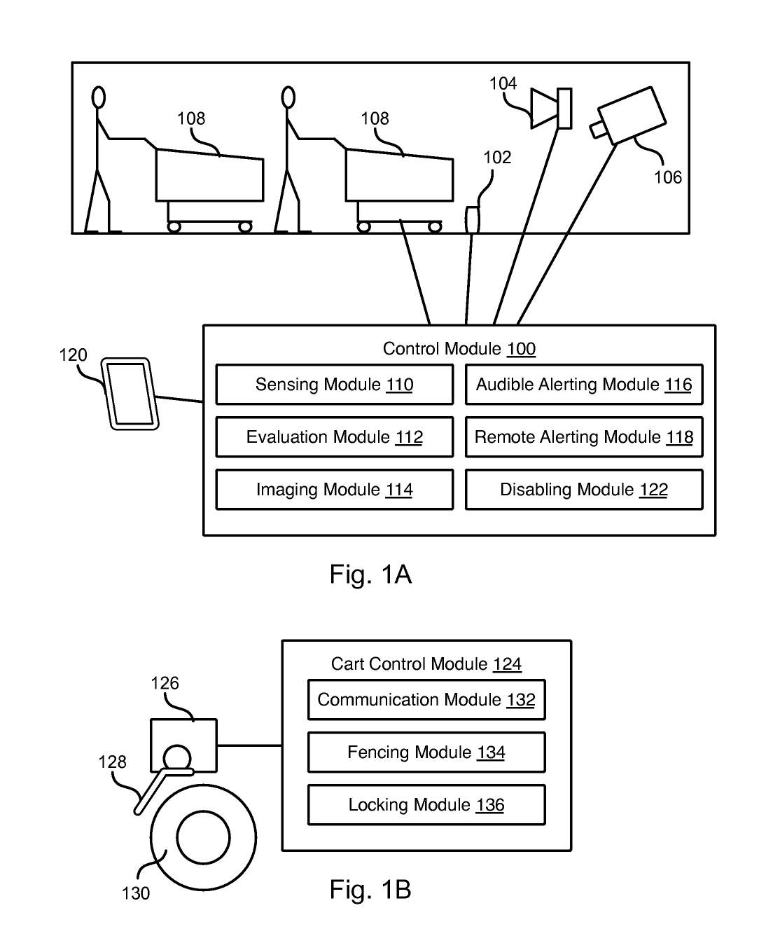

FIG. 1A illustrates a system for removing defective carts from circulation. The methods disclosed herein may be implemented by a control module 100. Some or all of the functionality ascribed to the control module 100 may be implemented locally to a store. Some or all of the functionality of the control module 100 may be executed at a location remote from a store.

The control module 100 may be in data communication with a microphone and one or more of a speaker 104, a camera 106, and a shopping cart 108. As shown in FIG. 1A, a microphone 102 may be placed at wheel level of a shopping cart. The microphone 102 may additionally placed in a lane or constriction where shopping carts are constrained to pass or are likely to pass. For example, a microphone 102 may be placed at an opening to a cart return station, at a doorway, along a commonly used aisle, or at some other position.

In a like manner, a camera 106 may be a still image camera or video camera and may be positioned and oriented effective to capture an image of a cart that is positioned sufficiently close to the microphone 102 such that an acoustic signature of the cart can be detected by the microphone. In some embodiments, the camera 106 may also be positioned at wheel level or at about wheel level effective to image the cart or a portion of the cart adjacent the microphone 102.

The control module 100 may include a sensing module 110 that is programmed to receive an output of the microphone 102. The sensing module 110 may record or otherwise capture an output of the microphone for subsequent analysis. The sensing module 110 may, for example, begin recording upon detecting a sound above a given decibel level, or above a given decibel level in a given frequency range, and record for a fixed time period or until the detected sound falls below a given decibel level, or below a given decibel level in a given frequency range. In other embodiments, the sensing module 110 may constantly receive an output of the microphone and output a conditioned version of the received output. For example, the sensing module 110 may convert an analog output of the microphone to a digital signal and perform any other signal processing functions such as filtering, normalizing, or the like.

The control module 100 may include an evaluation module 112 that receives an output of the sensing module. The evaluation module 112 may analyze the output of the sensing module in order to characterize the output and determine whether the output indicates a defective cart. The operation of the evaluation module is described in greater detail hereinbelow.

Where the evaluation module indicates a defective cart, the control module 100 may invoke one or more cart-removal actions. For example, a control module 100 may invoke an audible alerting module 116 to play an audible alarm or message over the speaker 104. The control module 100 may invoke a remote alerting module 118 to send a message to messaging device 120 of a store employee. For example, the messaging device 120 may be a cell phone operable to receive text messages, a pager, or some other device. The control module 100 may invoke a disabling module 122 to send a wireless signal to a shopping cart 108 to activate a wheel lock.

The control module 100 is exemplary only, and a control module 100 for implementing methods disclosed herein may perform less than all of the functions ascribed to the control module 100. For example, cart-removal actions need not include all of the functions of the modules 116-122.

FIG. 1B illustrates a cart control module 124 that may be mounted to a shopping cart 108 or otherwise interface with a shopping cart 108. The cart control module 124 may be coupled to an actuator 126 coupled to a brake 128. The brake 128 is positioned to selectively engage a wheel 130 or an axle of a wheel 130 in order to hinder movement of the wheel 130.

The cart control module 124 may include a communication module 132 operable to be in data communication with the control module 100 by means of any wireless networking protocol. The cart control module 124 may include a fencing module 134. In some stores, shopping carts include locks that are activated when a cart is taken outside of a given area such as a store or parking lot. For example, coils may be buried in a parking lot and be excited at a frequency to which the cart control module is sensitive. Various other geo-fencing approaches known in the art may also be used including global positioning system (GPS) systems that can be programmed to take action when a device leaves a proscribed region.

The cart control module 124 may include a locking module that is operable to invoke the actuator 126 and lock the wheel 130 upon the occurrence of a condition such as leaving a geo-fencing region or receipt of a locking signal from a control module 100. In some embodiments a locking module 136 may be operable only to lock the wheel 130 upon receipt of a locking signal without regard to any geo-fencing.

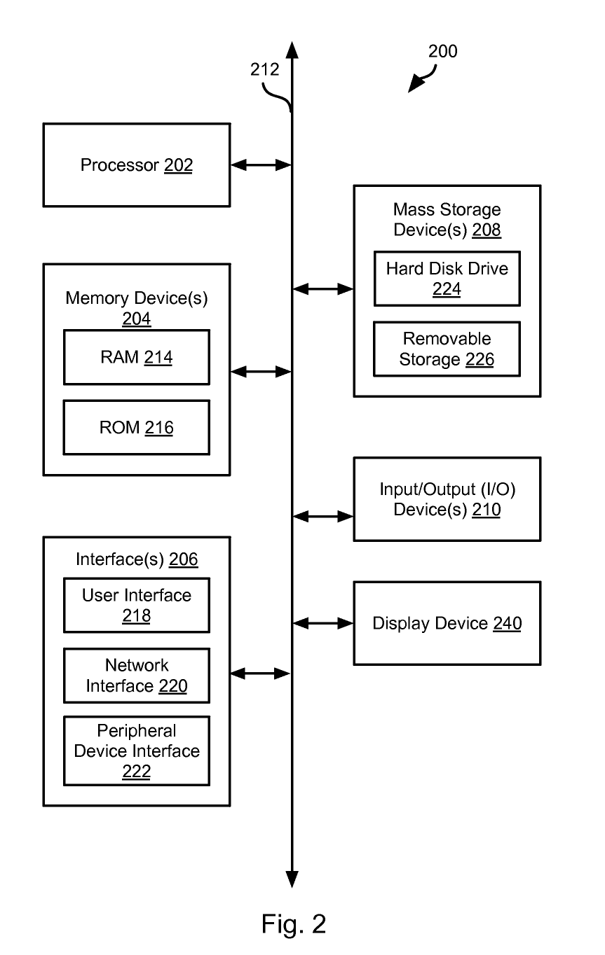

FIG. 2 is a block diagram illustrating an example computing device 200. Computing device 200 may be used to perform various procedures, such as those discussed herein. A control module 100 and cart control module 124 may include some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

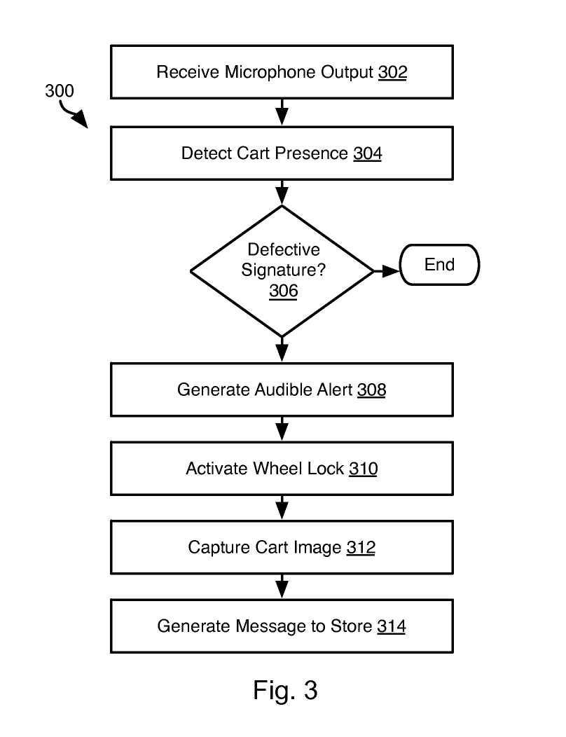

FIG. 3 illustrates a method 300 for removing defective carts from circulation. The method 300 may include receiving 302 an output of a microphone 102. Receiving 302 an output of a microphone may include performing signal processing functions such as recording the microphone output for a discrete period of time, digitizing the output of the microphone 102, filtering the output of the microphone 102, or performing other signal processing functions.

The method 300 may also include detecting 304 presence of a cart and evaluating 306 whether the sound recorded is indicative of a defective cart. In some embodiments, detecting 304 presence of a cart is omitted and only evaluation of whether a detected sound indicates a defective cart is performed. Detecting 304 presence of a cart may include such steps as determining whether a decibel level of recorded sound, or a decibel level of recorded sound within a specific frequency range, is indicative of proximity of a cart, evaluating whether the spectral content of a recorded sound is indicative of presence of a cart, or some other means of detecting a cart, including detecting the cart in an camera output, using inductive coils, or some other means of metal detection.

Evaluating 306 whether the sound signature is indicative of a defective cart may include comparing the recorded sound to pre-recorded signatures for known defective carts. Evaluating 306 whether the sound signature is indicative of a defective cart may additionally or alternatively include comparing spectral content of the sound signature to frequencies or frequency bands at which defective bearings or skidding wheels emit sound.

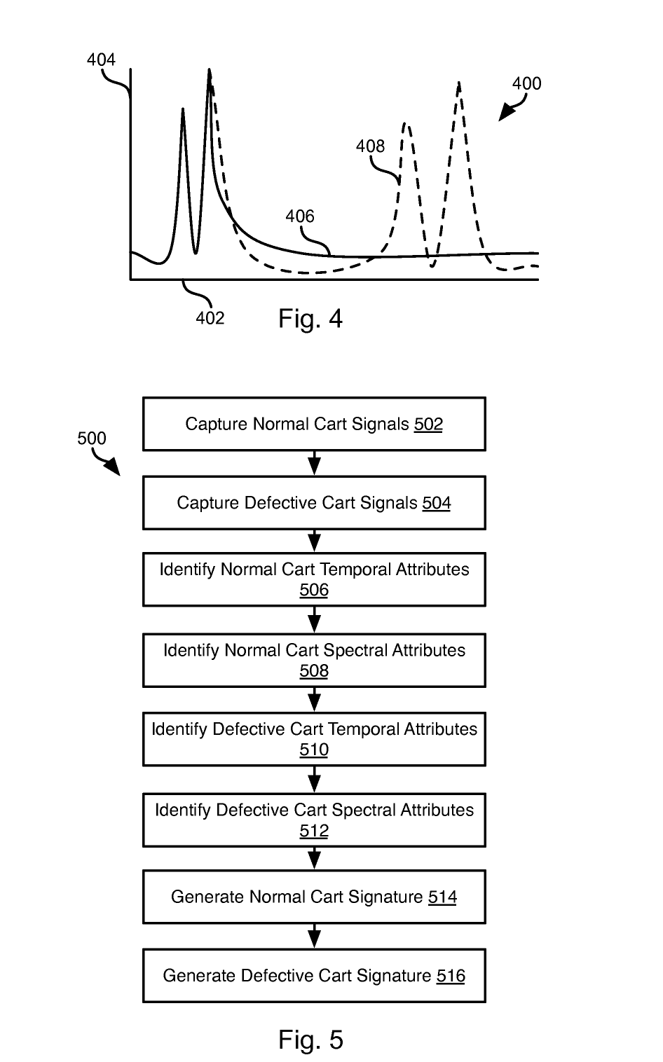

For example, referring to FIG. 4, while still referring to FIG. 3, a plot of the Fourier transform (e.g. a discrete time Fourier transform, discrete Fourier transform, fast Fourier transform) of a signal may plot the power of a signal (axis 404) with respect to frequency (axis 402). Many signals will exhibit peaks at particular frequencies. For example, plot 406 may reflect a Fourier transform of a normal cart with peaks at certain frequencies. A plot 408 may represent a Fourier transform of a defective cart. As is apparent the plot 408 includes peaks at different frequencies that are of large amplitude. Accordingly, evaluating whether a sound signature indicates a defective cart may include determining if the Fourier transform of a measured signal include frequency content above a threshold level at one or more frequencies for which a normal cart does not emit frequencies or does not emit frequencies above the threshold. In some embodiments, an absence of spectral power in a frequency or frequency band at which a properly functioning cart emits sound may be interpreted as an indication that a cart is defective.

In some embodiments, a defective cart may simply be very loud such that a recorded signal that is above a certain decibel level at any frequency or within one or more frequency bands is interpreted as indicating a defective cart. In some embodiments, a correlation between a signal and patterns for known defective and functional carts may be computed to determine whether the sound signature of a cart indicates that the cart is defective or functional. Any method known in the art for detecting patterns or attributes of a signal may be used to compare the sound signature of a cart to a signature of one or more carts known to be defective or functional in order to determine whether a cart is defective. A combination of any of the foregoing signal attributes may be used, such as by means of a weighted combination in order to identify whether a signal is indicative of a defective cart.

Referring again to FIG. 3, if cart is not found 306 not to be defective the method 300 may end with respect to the signal being analyzed. If a cart is found to be defective, then one or more cart-removal actions may be taken, including some or all of the actions listed in FIG. 3. For example, an audible alert may be generated 308 alerting a customer that cart is defective. An audible alert may additionally include an instruction to take the cart to an area reserved for defective carts, particularly where it is anticipated that the person pushing the cart is likely an employee.

In some embodiments a wheel lock, such as the wheel lock illustrated in FIG. 1B, may be activated 310, such as by transmitting a wireless signal to the wheel lock. The signal may have a magnitude such that only a wheel lock proximate a microphone 102 without disabling other carts in the store. For example, where a cart has width, the range at which the signal emitted to activate a wheel lock may be constrained to be less than the width of a cart or a multiple of the width of the cart.

In some embodiments, an image of the defective cart may be captured 312, such as by means of a camera 106. A cart may include an identifier located at a position that is viewable by the camera. For example, the camera may be located proximate a microphone 102 such that upon detecting the defective wheel of a cart traveling past the microphone 102, a picture taken will contain an image of the identifier. In some embodiments capturing 312 an image may include extracting the identifier from a captured image.

In some embodiments, a message may be generated 314 and transmitted to a store representative such as by means of text message, email, or the like. The generated 314 message may include an identifier of a shopping cart captured by means of an identifier captured from an image, a radio frequency identifier (RFID) tag affixed to a cart, or the like. The generated 314 message may additionally or alternatively include an indicator of the location of the microphone 102 that sensed the defective cart in order to enable the store representative to remove the cart from circulation.

FIG. 5 illustrates a method 500 for identifying normal and defective cart signatures. The method 500 may include capturing 502 normal cart signatures and capturing 504 defective cart signatures. In some embodiments, capturing 504 defective cart signatures may include capturing multiple samples of multiple types of defects. For example, a sample set of a wheels with defective bearings that still rotates slightly being rotated at typical walking speed may be recorded. Likewise, a sample set of a completely locked wheels skidding across a typical store floor surface may be taken. In some embodiments, sample sets of recording may be recorded for bearings at multiple stages of malfunction. In such embodiments, alerts that recognize a signature may indicate an estimate of the remaining life of a shopping cart wheel and bearings.

For a sample set of recordings of functional carts, the method 500 may include one or both of identifying 506 attributes of the recorded signals in the time domain and identifying 508 attributes of the recorded signals in the frequency domain. Identifying 506 temporal attributes and Identifying 508 spectral attributes may include recognizing any pattern known in the art of signal processing, speech recognition, or other field. Attributes in the frequency domain may by identified 508 by summing or otherwise combining Fourier transforms of the recorded signals and using the combination as a the spectral profile against which subsequent recordings of carts can be compared, such as by computing the correlation between the combined sample signals and a signal for a shopping cart that is being tested.

The method of claim 500 may additionally include, for each sample set of defective carts, identifying 510 attributes of the signals in the time domain and identifying 512 attributes of the signals in the frequency domain. Identifying 510, 512 attributes in the time and frequency domains may be performed in the same fashion as described above for normal carts. As already noted, attributes may be identified for signals corresponding to a particular defect for a plurality of defect types such that a plurality of defective cart signatures are generated in one or both of the time domain and frequency domain. As also previously noted, sample sets of carts at different stages of malfunction up to complete locking may be recorded and signatures generated for each sample set. In this manner, if a cart is found to match one of these signatures, the remaining useful life of the cart may be inferred to be that of the sample set used to generate the matching signature.

The method 500 may further include generating 514 one or more normal cart signatures 514 and generating 516 one or more defective cart signatures. A signature may include both temporal and spectral attributes identified in the foregoing steps. In some embodiments, only those temporal or spectral attributes that are unique to a particular cart status (normal, or having a specific defect) are included in the signature, e.g. those spectral or temporal attributes that are not common to other cart statuses are included in the signature for that cart status. The signatures 514, 516 generated according to the method 500 may be used in the foregoing methods in order to identify defective carts and remove them from circulation.

The invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for defective shopping cart detection, the method comprising:
detecting, by a computer system, a sound emitted from a shopping cart;
evaluating, by the computer system, a signature of the detected sound; and
invoking, by the computer system, a cart-removal action if the signature of the detected sound indicates a defective shopping cart.

2. The method of claim 1, wherein the cart-removal action is an audible alert.

3. The method of claim 2, wherein the audible alert is a spoken message communicating that the cart is defective.

4. The method of claim 1, wherein the cart-removal action is an electronic message to a store representative.

5. The method of claim 4, wherein the electronic message is a text message to a mobile computing device.

6. The method of claim 1, wherein the cart-removal action is capture of an image of the shopping cart.

7. The method of claim 6, further comprising extracting a cart identifier from the captured image.

8. The method of claim 7, further comprising transmitting the cart identifier in an electronic message to a store representative.

9. The method of claim 1, wherein the cart-removal action comprises invoking locking of a wheel lock on the shopping cart.

10. The method of claim 1, wherein the wheel lock is a geo-fencing lock.

11. The method of claim 1, wherein evaluating, by the computer system, the signature of the detected sound comprises performing Fourier analysis of the detected sound.

12. A system for defective shopping cart detection, the system comprising:
a microphone;
a controller operably coupled to the microphone and programmed to:
receive an output of the microphone;
evaluate a signature of the detected sound; and
invoke a cart-removal action if the signature of the detected sound indicates proximity of a defective shopping cart.

13. The system of claim 12, further comprising a speaker proximate the microphone and wherein the controller is further programmed to invoke the cart-removal action by causing the speaker to generate an audible alert.

14. The system of claim 12, wherein the controller is further programmed to invoke the cart-removal action by transmitting an electronic message to a store representative.

15. The system of claim 12, further comprising a camera operably coupled to the controller; and
wherein the controller is further programmed to capture an image of the defective shopping cart.

16. The system of claim 15 wherein the controller is further programmed to extract a cart identifier from the captured image.

17. The system of claim 16, wherein the controller is further programmed to transmit the cart identifier in an electronic message to a store representative.

18. The system of claim 12, further comprising a wheel lock secured to the defective shopping cart; and
wherein the controller is further programmed to invoke the cart removal action by wirelessly instructing the wheel lock to lock a wheel of the defective shopping cart.

19. The system of claim 18, wherein the wheel lock comprises a geo-fencing lock configured to lock the wheel of the defective shopping cart from a proscribed zone.

20. The system of claim 12, wherein the controller is further programmed to evaluate the signature of the detected sound by performing Fourier analysis of the detected sound.
